(19) United States
(12) Patent Application Publication
(10) Pub. No.: US 2023/0047542 A1
(43) Pub. Date: Feb. 16, 2023

(54) STRETCHABLE SENSOR

(71) Applicant: The University of Dundee, Dundee (GB)

(72) Inventor: Luigi MANFREDI, Dundee (GB)

(21) Appl. No.: 17/791,128

(22) PCT Filed: Jan. 14, 2021
(86) PCT No.: PCT/GB2021/050079

§ 371 Date: Jul. 6, 2022

(30) Foreign Application Priority Data
Jan. 14, 2020 (GB) 2000515.3

(51) Int. Cl. B25J 19/02; G01L 1/12

(52) U.S. Cl. CPC B25J 19/027; G01L 1/122

(57) ABSTRACT

There is disclosed a stretchable sensor system for measuring deformation of an elastomer, the stretchable sensor system comprising at least one magnet; at least one magnetic sensor, each having a sensor output; and a controller, wherein the at least one magnet is/are fixed to the elastomer at a respective first location or plurality of locations and the at least one magnetic sensor is/are fixed to the elastomer at a respective second location or plurality of locations, such that the or each magnetic sensor is located in magnetic proximity to a respective said magnet, and wherein the controller is operable: to receive sensor data from the sensor output of the or each magnetic sensor; to process the received sensor data in dependence on the first and second locations or plurality of locations to determine a positional relationship between the or each magnet and the respective magnetic sensor; and to compute a deformation of the elastomer in dependence on the determined positional relationship between the or each magnet and the respective magnetic sensor. The present invention has particular application to soft robotics and closed loop control thereof.

### FIELD OF THE INVENTION

The present invention relates to a stretchable sensor system, a controller for measuring deformation of an elastomer, related methods, and a computer readable medium. It finds particular application in the field of soft robotics and closed loop control thereof.

### BACKGROUND OF THE INVENTION

Soft robotics is a new research area where soft materials (elastomers) are used to build robots rather than using traditional rigid materials. As an advantage, the robot is safer than a rigid one because of a low Young's modulus, which make the material softer and it reduces the impact and any damage if in contact with a human. A current limitation is the need of sensors to measure the robot link/joint deformation. Conventional sensors cannot be used because of their rigidity. Stretchable sensors have been developed by using conductive materials mixed with elastomers. They can provide high sensitivity and mechanical bandwidth, but also high noise and low reliability when connected to an external electronic board for data acquisition. Constructing reliable external pads to acquire the sensors output signal is also a challenge with that type of sensor. Optical fibres have also been used to measure the elastomer deformation, although this type of sensor is typically unreliable, fragile, and the signal processing hardware is expensive and difficult to scale down in dimension.

The present invention aims to solve the problems mentioned above, and to address the identified needs.

### SUMMARY OF THE INVENTION

According to a first aspect of the present invention, there is provided a stretchable sensor system for measuring deformation of an elastomer, the stretchable sensor system comprising: at least one magnet; at least one magnetic sensor, each having a sensor output; and a controller, wherein the at least one magnet is/are fixed to the elastomer at a respective first location or plurality of locations and the at least one magnetic sensor is/are fixed to the elastomer at a respective second location or plurality of locations, such that each magnetic sensor is located in magnetic proximity to a respective said magnet, and wherein the controller is operable: to receive sensor data from the sensor output of the or each magnetic sensor; optionally to process the received sensor data in dependence on the first and second locations or plurality of locations to determine a positional relationship between the or each magnet and the respective magnetic sensor; and optionally to compute a deformation of the elastomer in dependence on the determined positional relationship between the or each magnet and the respective magnetic sensor.

According to one embodiment, the stretchable sensor system comprises a plurality of magnets and a plurality of magnetic sensors.

The sensor system of the present invention can measure deformation on arbitrarily complicated shapes, and can provide a relatively low noise, low response time system due to the relatively direct link between magnetic field strength and distance. The use of magnets and magnetic sensors can also avoid a mechanical limitation on the amount of extension of the elastomer.

Preferably the magnetic sensor is a Hall Effect sensor, benefiting from the simplicity of design, reliability and robustness of such sensors in general. Alternatively other forms of sensor may be used, such as a magnet-based device detecting forces or accelerations on an embedded magnet, for example, or (less usefully) an inductance-based device, and so on. The use of a Hall Effect sensor can further improve the noise and response properties of a system. A Hall Effect sensor typically only requires a simple A/D convertor to obtain a sensor reading. Often such a convertor is integrated in DSP systems. Thus, the sensor system may in some forms comprise only the electronic elements of Hall Effect sensors and a DSP, potentially allowing a considerable cost reduction and so on. Preferably the Hall Effect sensors and magnets are aligned so as to cause the largest possible magnetic field strength to be detected (thereby improving the signal to noise ratio). Preferably the magnetic sensor is capable of detecting the magnitude of magnetic field strength, rather than detecting only changes in magnetic field strength (as is the case with inductors, for example). Changes in absolute voltage are relatively easier to measure than voltage spikes corresponding to changes of field strength over time, and they do not require such high sampling rates. Thus, a more effective device can be provided if inductive components are avoided.

Preferably the magnets are permanent magnets, such as neodymium magnets or any other type. This can increase the simplicity and ease of installation; such magnets, being relatively small in dimension and having no external connections, can attached on, inside, or within the elastomer as appropriate, including being cast or glued into the bulk of the elastomer. Embedding at least one of the magnets and/or magnetic sensors within the elastomer can minimise unwanted additional movement and/or deformation. Alternatively the magnets could be any other appropriate source of a magnetic field such as an electromagnet or an inductor.

If there are a number of degrees of freedom of the elastomer that are desired to be measured, the first plurality and second plurality of locations may be selected so as to allow a measurement of all said degrees of freedom. Degrees of freedom may be independently variable displacements or lengths, angular rotations, shears, and so on, and may relate to the elastomer as a whole or to sub-portions or separate linkages within the elastomer, and so on. Degrees of freedom may in particular relate to the same property measured or adjusted in relation to orthogonal axes, but need not. That is to say, preferably the measured degrees of freedom relate to a plurality of points on or regions of the elastomer. Each degree of freedom, or at least one degree of freedom, may relate to a (different) respective location on the elastomer to the other degrees of freedom. It will be appreciated that this can provide more robust measurements which are less susceptible to unexpected conditions or interference, or a structural failure, in a single region of the elastomer. These are also particularly suitable features in the specific application of soft robotic actuators and the like.

The number of magnets (and, correspondingly, number of magnetic sensors) is preferably equal to the number of degrees of freedom that are desired to be measured. Accordingly, the magnets and magnetic sensors are deployed most efficiently. In some embodiments, yet further magnet and magnetic sensor pairs may be provided so as to provide redundancy and more accurate measurements.

Preferably the positional relationship for each magnet and respective magnetic sensor are computed independently of any other, such that, for example, measurements relating to each degree of freedom are computed in dependence on the output of (only) a single magnetic sensor. More preferably, measurements relating to each degree of freedom are computed in dependence on the influence of (only) a single magnet. In some cases more than one sensor may be provided within the range of at least one magnet as aforesaid, so long as there exists at least one pair of one (single) magnet and one (single) respective magnetic sensor. It will be appreciated that these various features can provide more robust measurements that are less susceptible to sensor or magnet malfunction or damage in a single location on the elastomer.

Also, by dividing the magnets and magnetic sensors into pairs, each pair being associated with a degree of freedom to be measured, an arbitrary number of degrees of freedom can be measured without requiring any structural change to the magnetic sensors or controller, and similarly, expanding the system to accommodate an additional degree of freedom does not require any structural change.

The aforementioned positional relationship between each magnet and the respective magnetic sensor is preferably the distance between each magnet and the respective magnetic sensor.

Alternatively or additionally, the positional relationship could be relative rotation, shear, or a more complicated relationship. Typically the relationship involves one degree of freedom or dimension, such as distance, but could involve more degrees of freedom or dimensions (for example an arbitrary rotation or vector having three degrees of freedom or dimensions). Preferably the magnetic sensor outputs only a single measurement, allowing a simplified design, but it is possible to incorporate magnetic sensors measuring multiple measurements, or having a vector rather than scalar output. In that case, the multiple measurements may be combined (for example, they may be averaged, or a maximum taken) or treated separately as appropriate.

The sensor output of each magnetic sensor is preferably substantially indicative of the distance to the respective magnet. This is true of Hall Effect sensors, for example. In more detail, the sensor output is preferably a measure of local magnetic field strength and is proportional to distance squared. The measurement is preferably scalar but can also be a vector or other n-dimensional quantity, as noted above.

At least two of the plurality of magnets and magnetic sensors may be oriented along the same axis. Indeed, all of the magnetic sensors may be oriented along the same axis. This can increase the ease of construction. Regardless, at least two of the plurality of magnets and magnetic sensors may measure a deformation about a different axis of the elastomer. There may be a range of suitable locations for placement of the magnets and magnetic sensors, but preferably they are chosen, in dependence of the specific geometry of a particular elastomer, so as to allow simple attachment (for example aligned in same axis or attached in a line, and so on) while measuring all necessary degrees of freedom. For example, if measuring the deformation a tube, sensors attached in an axial orientation and distributed uniformly around the same circumference of the tube can indicate at least local deformation of the tube in any direction (in that case in either of two degrees of freedom, either expressed as X and Y displacements, or as an angle and extent of bending, and so on).

Conversely, at least two of the plurality of magnets and magnetic sensors may be oriented along different axes. Whether and which magnet/sensor pairs are aligned, and which are not, will depend on the specific application and geometry of and constraints on the elastomer.

Preferably each magnetic sensor is positioned such that the magnetic field strength at the sensor originating from the respective magnet is greater than the combined magnetic field strength originating from all of the other magnets. In particular, the combined magnetic field strength originating from the other magnets is preferably less than 20, 10, 5, 2, 1, 0.5, 0.25 or 0.1% of the magnetic field strength originating from the respective magnet.

Preferably the controller is further operable to compute at least one force applied to the elastomer in dependence on the computed deformation of the elastomer. The controller may for example compute the force in dependence on factors including at least one of: the geometry of the elastomer, the local or global composition of the elastomer, and the resilience of the elastomer.

It will be appreciated that the relatively low noise and low response time of the aforesaid stretchable sensor system is advantageous for the purpose of closed loop control. Accordingly, in a further aspect of the invention there is provided a control system for controlling an elastomer, the control system comprising: an elastomer; a stretchable sensor system as aforesaid, attached to the elastomer; at least one actuator (such as a pneumatic or hydraulic actuator, and so on) for causing deformation of the elastomer; an input for inputting a desired deformation; and a closed loop controller for carrying out closed loop control of the actuator based on the desired deformation and the output of the stretchable sensor system. The closed loop controller is preferably operable to control a position of a portion of the elastomer.

In a further aspect of the invention there is provided a method of measuring deformation of an elastomer, the elastomer including at least one magnet and at least one magnetic sensor having a sensor output, the at least one magnet being fixed to the elastomer at a respective first location or plurality of locations and the at least one magnetic sensor being fixed to the elastomer at a respective second location or plurality of locations, such that the or each magnetic sensor is located in magnetic proximity to a respective said magnet, and the method comprising: receiving sensor data from the sensor output of the or each magnetic sensor; processing the received sensor data in dependence on the first and second locations or plurality of locations to determine a positional relationship between the or each magnet and the respective magnetic sensor; and computing a deformation of the elastomer in dependence on the determined positional relationship between the or each magnet and the respective magnetic sensor.

According to one embodiment, the elastomer comprises a plurality of magnets and a plurality of magnetic sensors.

In a yet further aspect of the invention there is provided a controller for measuring deformation of an elastomer, the elastomer including at least one magnet and at least one magnetic sensor having a sensor output, the at least one magnet being fixed to the elastomer at a respective first location or plurality of locations and the at least one magnetic sensor being fixed to the elastomer at a respective second location or plurality of locations, such that the or each magnetic sensor is located in magnetic proximity to a respective said magnet, and the controller comprising a processor and associated memory, the memory storing computer program code which, when executed by the processor, causes it to carry out a method as aforesaid.

In another aspect of the invention, there is provided a computer readable medium tangibly embodying computer program code which, when executed by a processor in communication with at least one magnetic sensor, fixed at a first respective location or plurality of locations on an elastomer, arranged in magnetic proximity to a respective at least one magnets, fixed at a second respective location or plurality of locations on the elastomer, causes the processor to carry out a method as aforesaid.

According to one embodiment, a plurality of magnetic sensors are fixed at a first respective plurality of locations on the elastomer arranged in magnetic proximity to a respective plurality of magnets, fixed at a second respective plurality of locations on the elastomer.

In yet another aspect of the invention there is provided a non-transitory computer readable medium tangibly embodying computer program code which, when executed by one or more computer processors, causes the computer to carry out a method as aforesaid.

Although the embodiments of the invention described herein with reference to the drawings may comprise computer-related methods or apparatus, the invention may also extend to program instructions, particularly program instructions on or in a carrier, adapted for carrying out the processes of the invention or for causing a computer to perform as the computer apparatus of the invention. Programs may be in the form of source code, object code, a code intermediate source, such as in partially compiled form, or any other form suitable for use in the implementation of the processes according to the invention. The carrier may be any entity or device capable of carrying the program instructions. The computer program code as aforesaid may be provided in any other appropriate and tangible form (such as a computer readable signal or encoded onto any general purpose or other computing device or hardware). The computer readable medium may, for example, be a CD, DVD, Blu-ray® disc, or similar, or a hard disk, solid state disk, integrated circuit, and so on.

Although various aspects and embodiments of the present invention have been described separately above, any of the aspects and features of the present invention can be used in conjunction with any other aspect, embodiment or feature where appropriate. For example apparatus features may where appropriate be interchanged with method features. References to single entities should, where appropriate, be considered generally applicable to multiple entities and vice versa. Unless otherwise stated herein, no feature described herein should be considered to be incompatible with any other, unless such a combination is clearly and inherently incompatible. Accordingly, it should generally be envisaged that each and every separate feature disclosed in the introduction, description and drawings is combinable in any appropriate way with any other unless (as noted above) explicitly or clearly incompatible.

### BRIEF DESCRIPTION OF THE DRAWINGS

The invention will now be described further, by way of example, with reference to the accompanying drawings, in which:

FIG. 1 is a schematic of a stretchable sensor system for use with an elastomer;

FIG. 2 is a schematic of a controller used in the system of FIG. 1;

FIG. 3 is a schematic of an example deployment of the stretchable sensor system of FIG. 1 on an elastomer;

FIG. 4 is another example deployment of the stretchable sensor system of FIG. 1, in relation to a soft pneumatic actuator;

FIGS. 5A and 5B are schematics of the actuator of FIG. 4 in longitudinal cross-section and in horizontal cross-section;

FIG. 6 is a further example deployment of the stretchable sensor system of FIG. 1;

FIGS. 7A and 7B are graphs illustrating the variation of sensed magnetic field strength and estimated distance over time during three interaction events;

FIG. 8 is a flow chart illustrating the process of determining the deformation of an elastomer carried out by the controller of FIG. 2;

FIG. 9 is a schematic of a closed loop control scheme including the stretchable sensor system of FIG. 1;

FIG. 10 is an example deployment of two pairs of magnets and magnetic sensors in the stretchable sensor system of FIG. 1; and

FIG. 11 is a further example deployment of two pairs of magnets and magnetic sensors in the stretchable sensor system of FIG. 1.

### DETAILED DESCRIPTION OF THE PREFERRED EMBODIMENT(S)

Various embodiments of a stretchable sensor system will now be described.

In overview, the preferred embodiment uses Hall Effect sensors to detect the magnetic field of permanent magnets located inside the elastomer: the deformation of the elastomer changes the distance of the permanent magnets from the Hall Effect sensors. The locations of both the magnets and the sensors are used to identify the shape of the elastomer. The measurement of the deformation of the elastomer can provide information not only related to its shape but also to measure the applied force since it is related to its mechanical properties.

The proposed design can be used for pneumatic actuators but also any application or device made from polymer with applications ranging from soft robotics, haptic soft wearable devices, medical devices (e.g. minimal access surgery, endoscopy), exoskeleton for rehabilitation and elderly people help, and so on. The present embodiment will now be described in more detail.

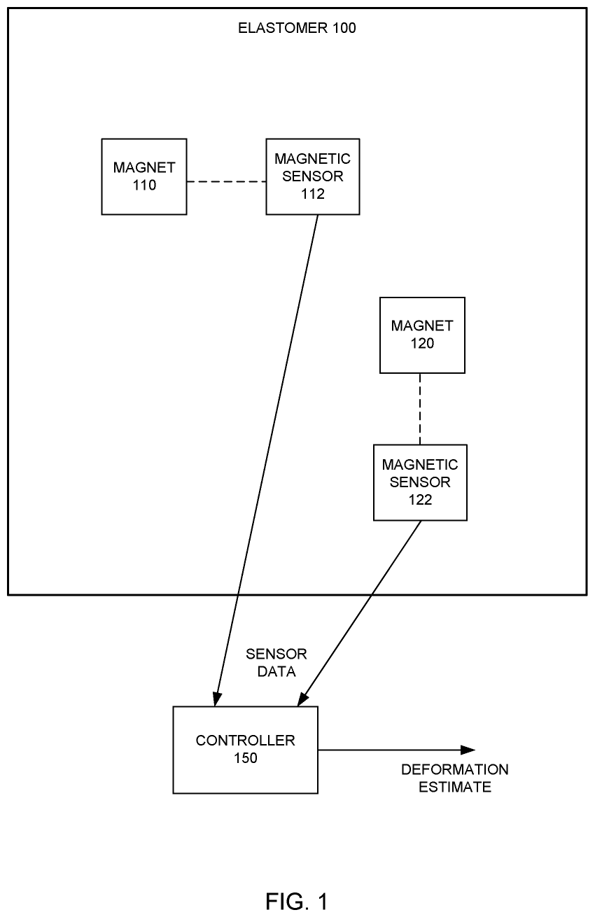

FIG. 1 is a schematic of a stretchable sensor system for use with an elastomer. On the elastomer 100, which may be essentially any appropriate deformable material having an appropriate shape and/or cross-section for a particular application, is disposed a pair of magnets 110, 120 and respective magnetic sensors 112, 122. The sensors 112, 122 output data to a controller 150, which processes the received sensor data to compute a deformation of the elastomer.

The magnet(s) and magnetic sensor(s) are securely fixed to specific known locations on, in, or within the elastomer, such that each magnetic sensor is located in magnetic proximity to each respective magnet. By ‘magnetic proximity’ it is meant that the field strength of the or each magnet is (significantly) measurable by each respective magnetic sensor. By appropriate selection of locations and choice of strength of magnet, each magnetic sensor is substantially unaffected by the magnetic field of magnets besides the other magnet in the pair. In the present embodiment, the magnets are permanent magnets, and the magnetic sensors are Hall Effect sensors.

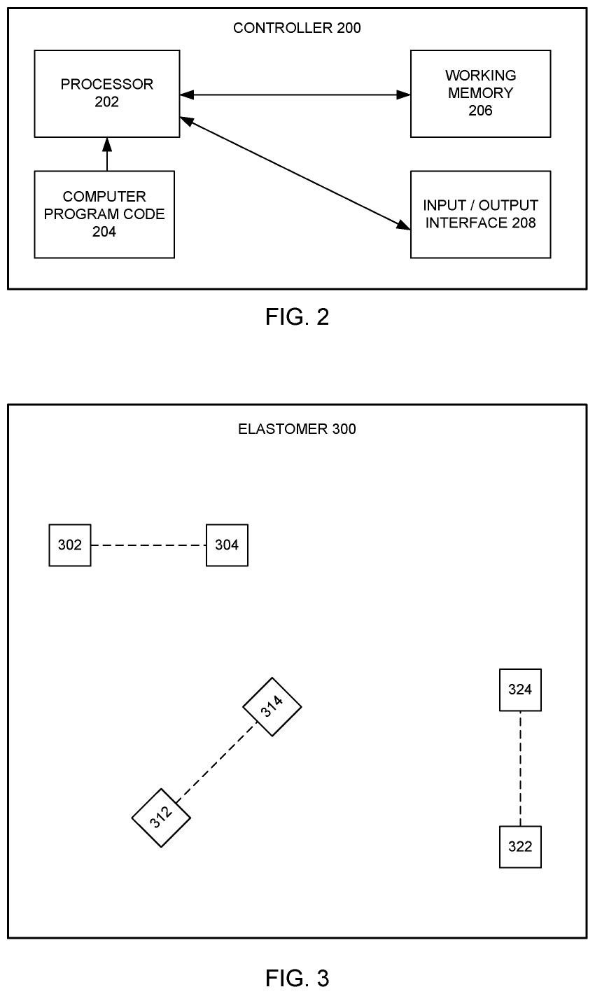

FIG. 2 is a schematic of a controller used in the system of FIG. 1. The controller 200 includes a processor 202, associated memory 204 containing computer program code for execution by the processor, an optional working memory 206 for storing received sensor data, intermediate computations, and the like, and an input/output interface 208 for communicating with the sensors and for outputting the deformation estimate. The controller 200 may in one variant be provided solely in hardware, but the same principles apply.

FIG. 3 is a schematic of an example deployment of the stretchable sensor system of FIG. 1 on an elastomer. On the elastomer 300, three pairs of magnet and sensor are provided. Magnet 302 and sensor 304 are provided in a horizontal configuration (as viewed) for measuring horizontal displacements. Magnet 312 and sensor 314 are provided in a diagonal configuration, and magnet 322 and sensor 324 are provided in a vertical configuration. In this case, the elastomer 300 (as an example) is substantially planar, and constrained at its bottom. There may for example be three degrees of freedom of deformation within the plane that are of interest for a particular application: horizontal stretching, vertical stretching (upwards) and horizontal shear, applied via the unconstrained edges of the elastomer 300. In this case, the horizontal and vertical sensors are sufficient to detect the stretching, but the additional diagonal sensor allows the detection of shear when compared to the outputs of the other sensors. Other sensor configurations are of course possible. Deformations of the elastomer 300 out of plane are in this case disregarded but could be detected with additional sensor placement(s).

It will be appreciated from this example that the magnet/sensor pairs are able to detect deformations in an essentially arbitrary number of degrees of freedom, and that these degrees of freedom need not (and in this case do not) correspond merely to the same type of deformation in respect of orthogonal axes. For example, the magnet/sensor pairs could be used to detect deformations in respect of X/Y/Z Cartesian axes (or, essentially, to determine a deformation vector of some type, such as force or displacement), but they are not so limited.

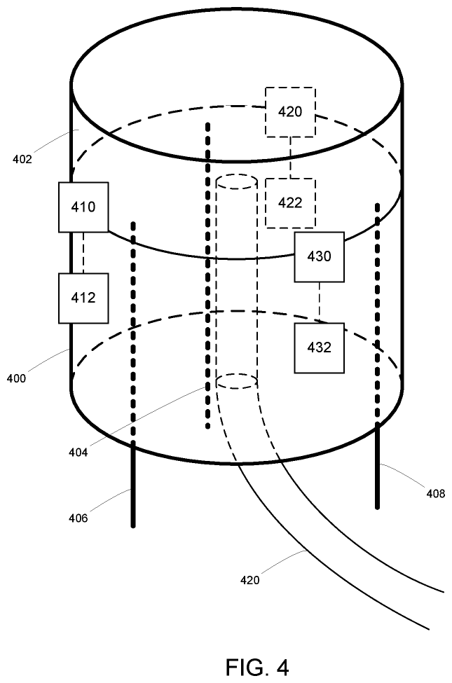

FIG. 4 is another example deployment of the stretchable sensor system of FIG. 1, in relation to a soft pneumatic actuator. The actuator body 400 is mostly formed from fibre-reinforced polymer, and includes a top reinforced section 402 and a bottom reinforced section (not shown for clarity). The body 400 includes tendons 404, 406, 408 and an air tube 420. The air tube 420 can be used to apply differing amounts of pneumatic pressure to the actuator 400, causing differing amounts of force to be applied by the top section 402. Magnet/sensor pairs are placed uniformly around the circumference of the actuator 400 (with 120 degrees between each). Magnetic sensors 410, 420, 430 and magnets 412, 422, 432 are shown. The top portion 402 is able to move with three principal degrees of freedom: bending in two orthogonal directions relative to the base, and displacement up and down (resisted by the fibres in the elastomer). Accordingly, three sensor pairs are provided.

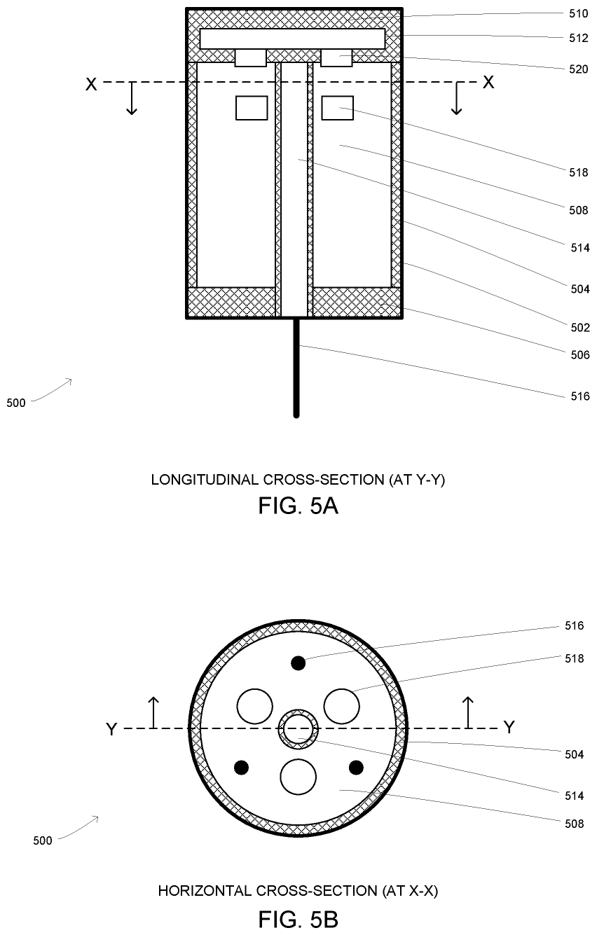

FIGS. 5A and 5B are schematics showing the actuator of FIG. 4 in longitudinal cross-section and in horizontal cross-section. As before, the actuator 500 includes an outer surface 502, a solid, fibre-reinforced, deformable outer wall 504, a bottom reinforced section 506, an inner cavity 508, a top reinforced section 510, an electronics board 512 embedded in the top section 510, an air tube 514, three tendons 516 (only one indicated for clarity), three permanent magnets 518 (only one indicated for clarity), and three Hall Effect sensors 520 (only one indicated for clarity) which are attached to the electronics board 512.

In connection with the illustrated design, it was discovered that the sensors have good performance in terms of low noise and fast response time, which are essential requirements for the implementation of a position closed-loop control.

To measure the 3 degrees of freedom of the actuator, the 3 magnet sensors are attached to the external actuator surface with an angle of 120° following the movement of the actuator. The magnets are small and the magnetic field affecting each other is negligible. Each Hall Effect sensor is in line with a permanent magnet at a distance dᵢ. When the actuator is activated, the deformation of its structure is followed by the permanent magnet and affects the distance dᵢ. This distance is related to the magnetic field (B) measured by the Hall Effect Sensor: B≈1/d². These 3 data points d₁, d₂, d₃ are proportional to the deformation of the actuator.

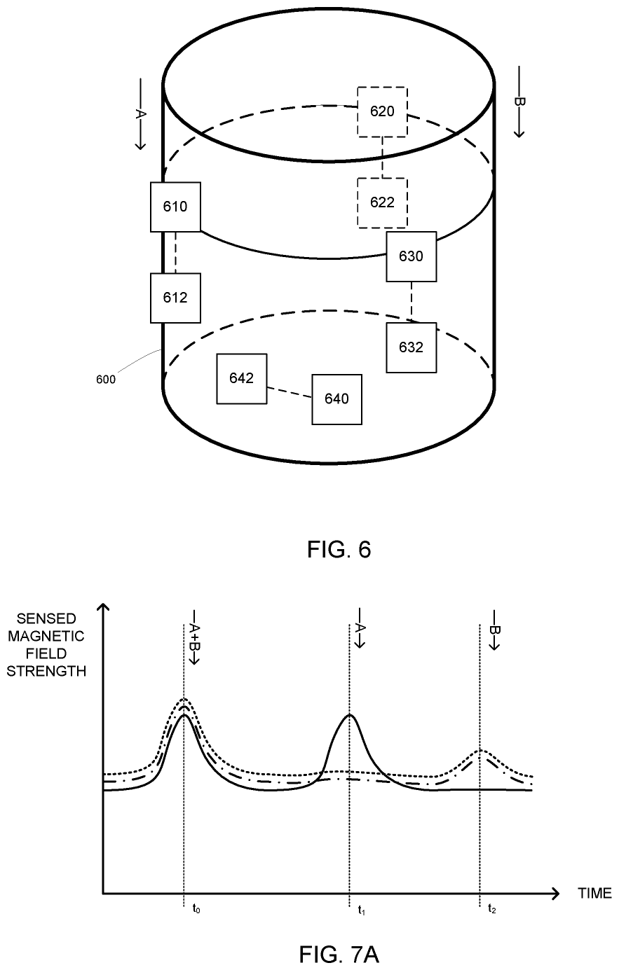

FIG. 6 is a further example deployment of the stretchable sensor system of FIG. 1. In FIG. 6, magnetic sensors 610, 620, 630, 640 and magnets 612, 622, 632, 642 are shown in relation to the actuator body 600. The actuator 600 of FIG. 6 is essentially the same as the actuator of FIG. 4 with a further magnet and sensor pair 642, 640 that measure a circumferential twisting of the actuator. Such a twisting is not normally of interest or easily achievable given the configuration of the fibre reinforcement in the elastomer, but 0 its measurement, in a circumferential direction, is nevertheless possible as a further degree of freedom that can be sensed and determined.

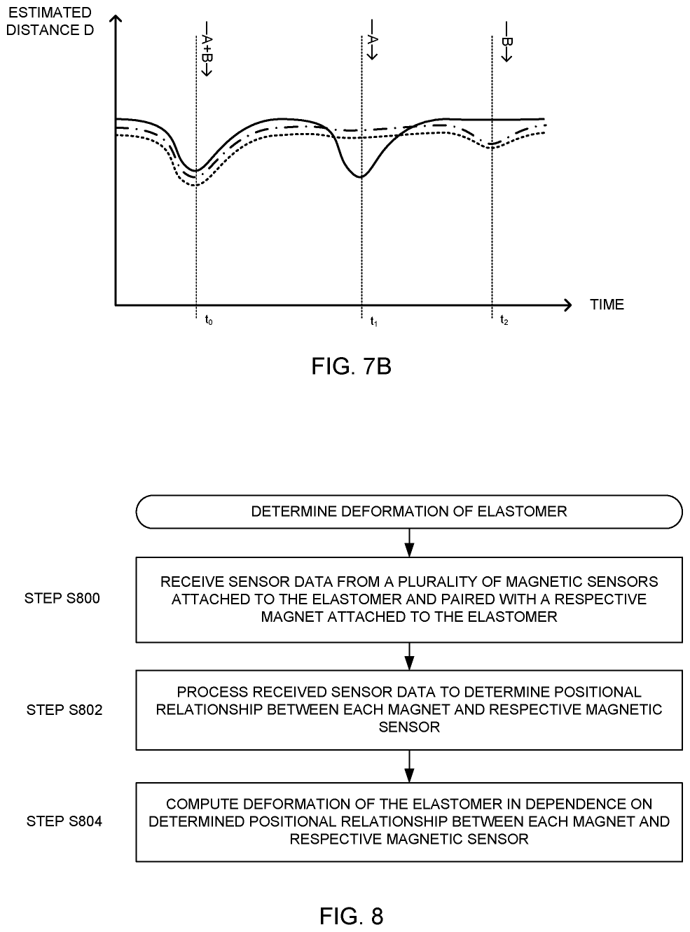

FIGS. 7A and 7B are graphs illustrating the variation of sensed magnetic field strength and estimated distance over time during three interaction events. In this example, the solid 5 line relates to sensor 612 of FIG. 6, the dotted line relates to sensor 622 of FIG. 6, and the dot-and-dash line relates to sensor 632 of FIG. 6. Three events at times t₀, t₁ and t₂ are shown, corresponding to pressing down centrally on the top portion of the actuator, pressing down on one edge (A) and pressing down on the other edge (B), respectively, as indicated with arrows in FIG. 6. As the sensors are pressed down, they approach closer to their respective permanent magnets, and the sensed magnetic field increases, as shown in FIG. 7A. As noted above, the sensed field strength is inversely proportional to the distance. By appropriate processing of that signal, a distance can be computed, as shown in FIG. 7B. A knowledge of appropriate distances (in this case d₁, d₂, d₃) and the locations of the magnets and magnetic sensors can then be used to determine the shape 5 and/or deformation of the elastomer, by using appropriate geometrical methods.

FIG. 8 is a flow chart illustrating the process of determining the deformation of an elastomer carried out by the controller of FIG. 2. In step S800, sensor data is received from a plurality of magnetic sensors attached to the elastomer and paired with a respective magnet attached to the elastomer. In step S802, received sensor data is processed to determine the positional relationship (for example distance) between each magnet and the respective magnetic sensor. In step S804, the deformation of the elastomer is computed in dependence on the determined positional relationship between each magnet and the respective magnetic sensor. The positional relationship is distance in the above examples, but it could also be an angular rotation or other measurement of position as appropriate to the specific embodiment of elastomer, and so on.

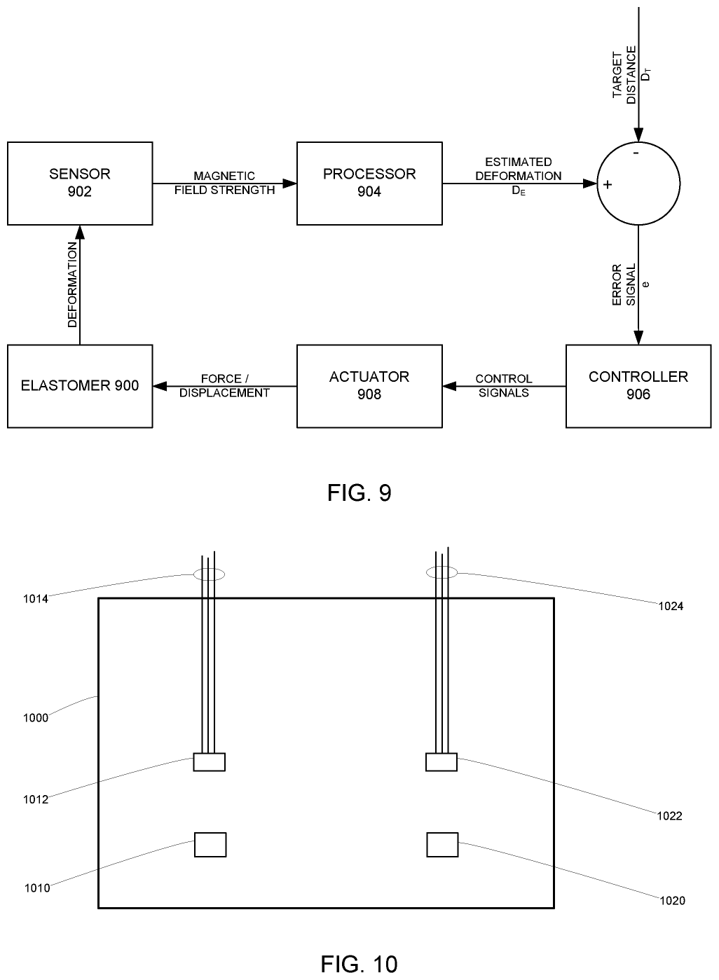

FIG. 9 is a schematic of a closed loop control scheme including the stretchable sensor system of FIG. 1. Such a scheme has not hitherto been possible due to excessive noise and/or slow response times of sensors. A deformation of an elastomer 900 is measured by a sensor 902, which outputs a measurement of magnetic field strength to a processor 904. The processor 904 processes the sensor readings and outputs an estimate DE of the deformation of a relevant part of the elastomer. The estimated deformation is subtracted from a set-point target distance DT (which may, for example, correspond to a zero displacement). The error signal e is fed to an actuator controller 906 which outputs control signals to cause an actuator 908 to apply a force or otherwise cause a displacement of the elastomer 900. These elements form a closed loop control system which can provide very rapid feedback to create a relatively responsive system.

FIG. 10 is an example deployment of two pairs of magnets and magnetic sensors in the stretchable sensor system of FIG. 1. In contrast to the systems of FIGS. 4 and 6, in which the Hall Effect sensor was embedded on a rigid electronics board, FIG. 10 illustrates a system in which a Hall Effect sensor is embedded directly within an elastomer 1000. A first magnet 1010, Hall Effect sensor 1012, and control circuitry 1014, and a second magnet 1020, Hall Effect sensor 1022, and control circuitry 1024 are shown. The circuitry 1014, 1024 can take any appropriate form, such as ordinary flexible electrical wires running on or in the elastomer, or more specialist transparent circuitry and/or circuitry formed directly on or in the elastomer, for example using deposition and/or etching techniques.

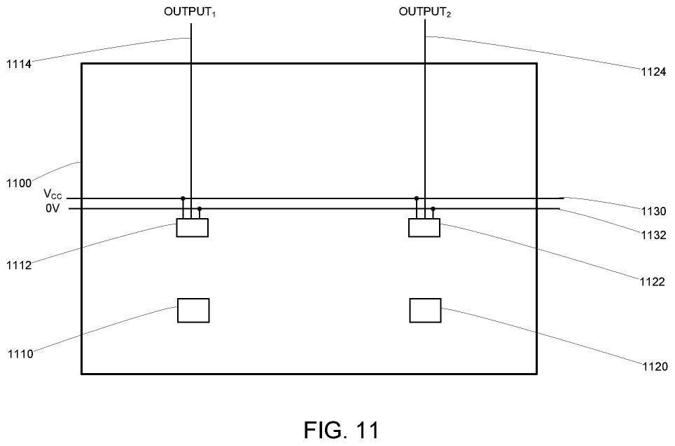

FIG. 11 is a further example deployment of two pairs of magnets and magnetic sensors in the stretchable sensor system of FIG. 1. This is essentially a version of the system of FIG. 10 but with a reduction in the amount of wiring, with the benefit of adding less stiffness to the elastomer, saving cost, and so on. The elastomer 1100 includes a first magnet 1110, Hall Effect sensor 1112 and sensor output line 1114, and a second magnet 1120, Hall Effect sensor 1122 and sensor output line 1124. In this case, the sensors are powered from a power line 1130 and ground line 1132. Consideration may need to be given as to placement of the wiring so as to mitigate any induction caused by movements of the magnets 1110, 1120, and so on. Adaptations can be made as necessary for versions of Hall Effect sensors having four connections rather than three.

It will be appreciated that other types of sensor can be used, such as GMR type sensors, although not necessarily being able to realise all advantages of the presently described system. It will also be appreciated that the presently described system is applicable to essentially any appropriate form of elastomer with differing materials, rigidity and so on. More complex shapes of elastomer, and more complex combinations of elastomer with rigid materials are of course possible.

It will be appreciated that further modifications may be made to the invention, where appropriate, within the spirit and scope of the claims.

1. A stretchable sensor system for measuring deformation of an elastomer, the stretchable sensor system comprising:
at least one magnet;
at least one magnetic sensor, each having a sensor output; and
a controller,
wherein the at least one magnet is/are fixed to the elastomer at a respective first location or plurality of locations and the at least one magnetic sensor is/are fixed to the elastomer at a respective second location or plurality of locations, such that the or each magnetic sensor is located in magnetic proximity to a respective said magnet, and
wherein the controller is operable:
to receive sensor data from the sensor output of the or each magnetic sensor;
to process the received sensor data in dependence on the first and second locations or plurality of locations to determine a positional relationship between the or each magnet and the respective magnetic sensor; and
to compute a deformation of the elastomer in dependence on the determined positional relationship between the or each magnet and the respective magnetic sensor.

2. The stretchable sensor system according to claim 1, comprising a plurality of magnets fixed to the elastomer at a respective first plurality of locations and a plurality of magnetic sensors fixed to the elastomer at a respective second plurality of locations.

3. The stretchable sensor system according to claim 1, wherein the magnetic sensor is a Hall Effect sensor.

4. The stretchable sensor system according to claim 1, wherein the magnets are permanent magnets.

5. The stretchable sensor system according to claim 1, wherein there are a number of degrees of freedom of the elastomer that are desired to be measured, and the first plurality and second plurality of locations are selected so as to allow a measurement of all said degrees of freedom.

6. The stretchable sensor system according to claim 5, wherein the number of magnets is equal to the number of degrees of freedom that are desired to be measured.

7. The stretchable sensor system according to claim 1, wherein the positional relationship is the distance between each magnet and the respective magnetic sensor.

8. The stretchable sensor system according to claim 1, wherein the sensor output of each magnetic sensor is substantially indicative of the distance to the respective magnet.

9. The stretchable sensor system according to claim 8, wherein at least two of the plurality of magnets and magnetic sensors are oriented along the same axis.

10. The stretchable sensor system according to claim 9, wherein said at least two of the plurality of magnets and magnetic sensors measure a deformation about a different axis of the elastomer.

11. The stretchable sensor system according to claim 10, wherein at least two of the plurality of magnets and magnetic sensors are oriented along different axes.

12. The stretchable sensor system according to claim 1, wherein each magnetic sensor is positioned such that the magnetic field strength at the sensor originating from the respective magnet is greater than the combined magnetic field strength originating from all of the other magnets.

13. The stretchable sensor system according to claim 1, wherein the controller is further operable to compute at least one force applied to the elastomer in dependence on the computed deformation of the elastomer.

14. A control system for controlling an elastomer, the control system comprising:
an elastomer;
a stretchable sensor system attached to the elastomer, the stretchable sensor system comprising;
at least one magnet;
at least one magnetic sensor, each having a sensor output; and
a controller,
wherein the at least one magnet is/are fixed to the elastomer at a respective first location or plurality of locations and the at least one magnetic sensor is/are fixed to the elastomer at a respective second location or plurality of locations, such that the or each magnetic sensor is located in magnetic proximity to a respective said magnet, and
wherein the controller is operable:
to receive sensor data from the sensor output of the or each magnetic sensor;
to process the received sensor data in dependence on the first and second locations or plurality of locations to determine a positional relationship between the or each magnet and the respective magnetic sensor; and
to compute a deformation of the elastomer in dependence on the determined positional relationship between the or each magnet and the respective magnetic sensor;
at least one actuator for causing deformation of the elastomer;
an input for inputting a desired deformation; and
a closed loop controller for carrying out closed loop control of the actuator based on the desired deformation and the output of the stretchable sensor system.

15. The control system according to claim 14, wherein the closed loop controller is operable to control a position of a portion of the elastomer.

16. A method of measuring deformation of an elastomer, the elastomer including a at least one magnet and at least one magnetic sensor having a sensor output, the at least one magnet being fixed to the elastomer at a respective first location or plurality of locations and the at least one magnetic sensor being fixed to the elastomer at a respective second location or plurality of locations, such that the or each magnetic sensor is located in magnetic proximity to a respective said magnet, and the method comprising:
receiving sensor data from the sensor output of the or each magnetic sensor;
processing the received sensor data in dependence on the first and second locations or plurality of locations to determine a positional relationship between the or each magnet and the respective magnetic sensor; and
computing a deformation of the elastomer in dependence on the determined positional relationship between the or each magnet and the respective magnetic sensor.

17. The method as claimed in claim 16, wherein the elastomer includes a plurality of magnets being fixed to the elastomer at a respective first plurality of locations and a plurality of magnetic sensors, being fixed to the elastomer at a respective second plurality of locations.

18. The method of claim 16, further comprising providing a controller for measuring deformation of the elastomer, the elastomer including at least one magnet and at least one magnetic sensor having a sensor output, the at least one magnet being fixed to the elastomer at a respective first location or plurality of locations and the at least one magnetic sensor being fixed to the elastomer at a respective second location or plurality of locations, such that the or each magnetic sensor is located in magnetic proximity to a respective said magnet, and the controller comprising a processor and associated memory, the memory storing computer program code.

19. The method of claim 16, further comprising providing a computer readable medium tangibly embodying computer program code which is operable to be executed by a processor in communication with at least one magnetic sensor, fixed at a first respective location or plurality of locations on an elastomer, arranged in magnetic proximity to a respective at least one magnet, fixed at a second respective location or plurality of locations on the elastomer.
